(19) United States
(12) Patent Application Publication
(10) Pub. No.: US 2017/0023258 A1
(43) Pub. Date: Jan. 26, 2017

(54) PANEL ASSEMBLIES FOR APPLIANCES

(71) Applicant: General Electric Company, Schenectady, NY (US)

(72) Inventor: Bangyong Keum, Louisville, KY (US)

(21) Appl. No.: 14/805,512

(22) Filed: Jul. 22, 2015

(51) Int. Cl. F24C 15/02; G06F 3/0488; F25D 25/02; F24C 7/08; F25D 29/00

(52) U.S. Cl. CPC F24C 15/02; F24C 7/081; F25D 29/005; F25D 25/02; G06F 3/0488

(57) ABSTRACT

Appliances having improved panel assemblies are provided. An appliance includes an appliance body and a panel assembly disposed on or within the appliance body. The panel assembly includes an outer surface and an inner surface. The panel assembly further includes a first layer including the outer surface, wherein the first layer is a glass, and a second layer at least partially in contact with and bonded to the first layer, wherein the second layer is a polymer.

### FIELD OF THE INVENTION

The present disclosure relates generally to panel assemblies in appliances, and more particular to appliance panel assemblies which have improved safety features.

### BACKGROUND OF THE INVENTION

Households and offices generally include a variety of appliances for performing a variety of functions. For example, a household may include a refrigerator appliance, a dishwasher appliance, a microwave appliance, an oven appliance, a washer appliance and/or a dryer appliance. Many of these appliances include various glass panels therein or thereon for performing various functions. For example, an appliance may include a user interface, which may for example utilize a touchscreen feature. The user interface may include a glass panel which operates as a component of the touchscreen. Additionally or alternatively, glass panels may be utilized in doors, such as in the door of an oven appliance, and/or may be utilized in shelves, such as in the shelves of a refrigerator appliance.

One issue that has arisen with presently known appliance glass panels relates to the safety of using such glass panels. For example, in many cases, tempered glass is utilized in glass panels. If a tempered glass panel breaks, however, it tends to shatter into extremely small chunks. These chunks can be easily missed by a user cleaning up the broken panel, and can cause injury to the user if they contact the user by becoming embedded in the user's skin.

Accordingly, improved panel assemblies for use in appliances are desired. In particular, appliance panel assemblies having improved safety features would be advantageous.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, an appliance is provided. The appliance includes an appliance body and a panel assembly disposed on or within the appliance body. The panel assembly includes an outer surface and an inner surface. The panel assembly further includes a first layer including the outer surface, wherein the first layer is a glass, and a second layer at least partially in contact with and bonded to the first layer, wherein the second layer is a polymer.

In accordance with another embodiment of the present disclosure, an oven appliance is provided. The oven appliance includes a cabinet defining a cooking chamber, the cooking chamber configured for receipt of items to be cooked. The oven appliance further includes a door rotatably mounted to the cabinet, the door comprising a panel assembly. The oven appliance further includes a controller, and a user interface in communication with the controller, the user interface comprising a panel assembly. At least one of the panel assembly of the door or the panel assembly of the user interface includes an outer surface and an inner surface. The at least one of the panel assembly of the door or the panel assembly of the user interface further includes a first layer including the outer surface, wherein the first layer is a glass, and a second layer at least partially in contact with and bonded to the first layer, wherein the second layer is a polymer.

In accordance with another embodiment of the present disclosure, a refrigerator appliance is provided. The refrigerator appliance includes a cabinet defining a fresh food chamber, and a fresh food door rotatably hinged to the cabinet for accessing the fresh food chamber. The refrigerator appliance further includes a shelf disposed within the fresh food chamber, the shelf including a panel assembly. The refrigerator appliance further includes a controller, and a user interface in communication with the controller, the user interface including a panel assembly. At least one of the panel assembly of the shelf or the panel assembly of the user interface includes an outer surface and an inner surface. The at least one of the panel assembly of the shelf or the panel assembly of the user interface further includes a first layer including the outer surface, wherein the first layer is a glass, and a second layer at least partially in contact with and bonded to the first layer, wherein the second layer is a polymer.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an oven appliance in accordance with one embodiment of the present disclosure;

FIG. 2 provides a sectional view of the oven appliance of FIG. 1 taken along the line 2-2 of FIG. 1;

FIG. 3 provides a front view of a refrigerator appliance in accordance with one embodiment of the present disclosure;

FIG. 4 provides a front view of the refrigerator appliance of FIG. 3 with refrigerator doors of the refrigerator appliance shown in an open configuration to reveal a fresh food chamber and freezer chambers of the refrigerator appliance;

FIG. 5 is a side schematic view of a panel assembly for an appliance in accordance with one embodiment of the present disclosure;

FIG. 6 is a side schematic view of a panel assembly for an appliance in accordance with another embodiment of the present disclosure; and

FIG. 7 is a side schematic view of a panel assembly for an appliance in accordance with another embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

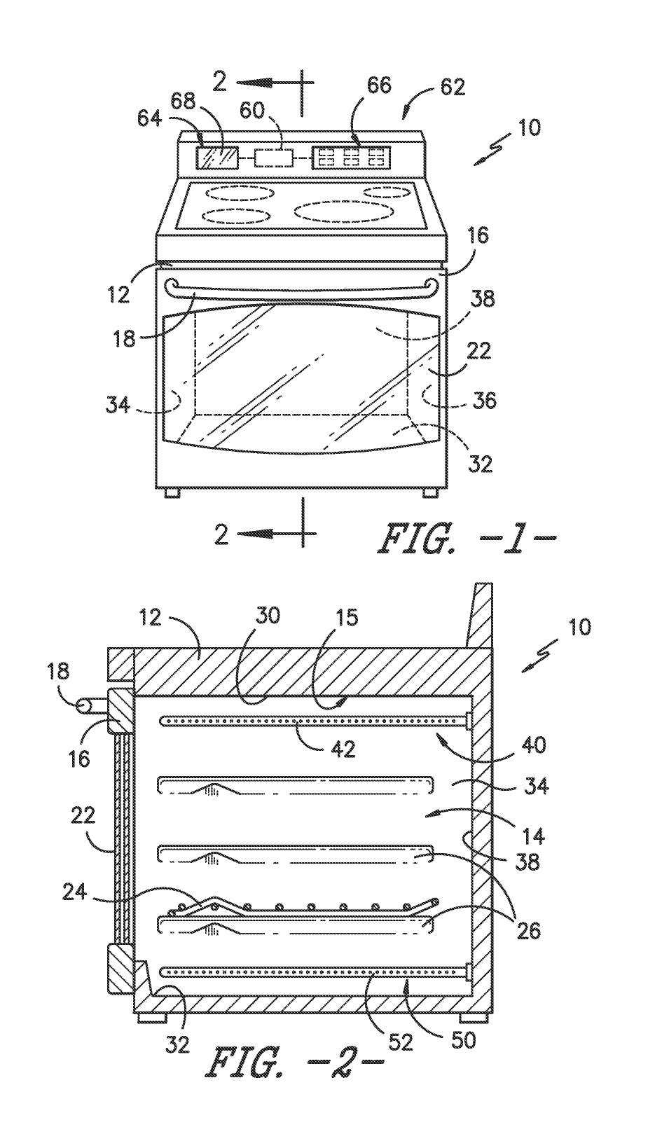

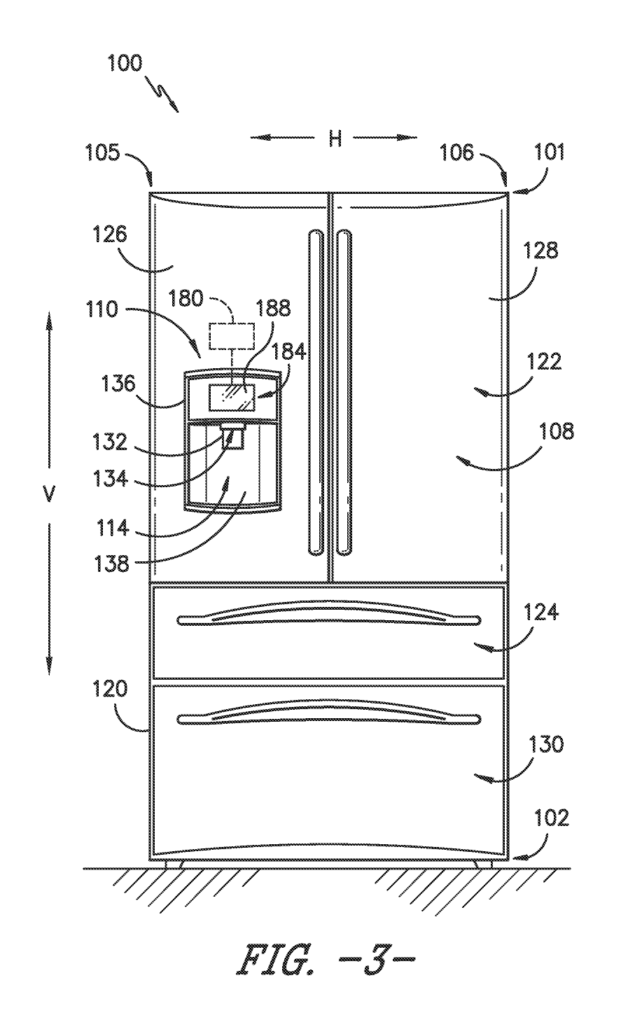

FIG. 1 provides a perspective view of an oven appliance 10 according to an exemplary embodiment of the present subject matter. FIG. 2 provides a section view of oven appliance 10 taken along the 2-2 line of FIG. 1. Oven appliance 10 defines a vertical direction V, a lateral direction L and a transverse direction T. The vertical, lateral and transverse directions are mutually perpendicular and form an orthogonal direction system. As will be understood by those skilled in the art, oven appliance 10 is provided by way of example only, and the present subject matter may be used in any suitable oven appliance. Thus, the present subject matter may be used with other oven or range appliance configurations, e.g., that define multiple interior cavities for the receipt of food and/or having different pan or rack arrangements than what is shown in FIG. 2.

Oven appliance 10 includes an insulated cabinet 12 with an interior cooking chamber 14 defined by an interior surface 15 of cabinet 12. Cooking chamber 14 is configured for the receipt of one or more food items to be cooked. Oven appliance 10 includes a door 16 rotatably mounted to cabinet 12, e.g., with a hinge (not shown). A handle 18 is mounted to door 16 and assists a user with opening and closing door 16 in order to access cooking chamber 14. For example, a user can pull on handle 18 to open or close door 16 and access cooking chamber 14.

Oven appliance 10 can includes a seal (not shown) between door 16 and cabinet 12 that assist with maintaining heat and cooking fumes within cooking chamber 14 when door 16 is closed as shown in FIG. 2. Multiple parallel panel assemblies 22 provide for viewing the contents of cooking chamber 14 when door 16 is closed and assist with insulating cooking chamber 14. A baking rack 24 is positioned in cooking chamber 14 for the receipt of food items or utensils containing food items. Baking rack 24 is slidably received onto embossed ribs 26 or sliding rails such that rack 24 may be conveniently moved into and out of cooking chamber 14 when door 16 is open.

As shown, various sidewalls define the cooking chamber 14. For example, cooking chamber 14 includes a top wall 30 and a bottom wall 32 which are spaced apart along the vertical direction V. Left sidewall 34 and right sidewall 36 (as defined according to a front view as shown in FIG. 2) extend between the top wall 30 and bottom wall 32, and are spaced apart along the lateral direction L. A rear wall 38 may additionally extend between the top wall 30 and bottom wall 32 as well as between the left sidewall 34 and right sidewall 36, and is spaced apart from the door 16 along the transverse direction T. Cooking chamber 14 is thus defined between the top wall 30, bottom wall 32, left sidewall 34, right sidewall 36, and rear wall 38.

A lower burner assembly 40, e.g., a bake burner assembly may be included in oven appliance 10. Lower burner assembly 40 may include a heating element 42 which is disposed within the cooking chamber 14, such as adjacent the bottom wall 32. In exemplary embodiments as illustrated, the lower burner assembly 40 is a gas burner assembly, and the heating element 42 is thus a gas burner tube. Alternatively, the lower burner assembly 40 may be an electric burner assembly and thus include an electric heating element, or may be any other suitable burner assembly having any other suitable heating element.

An upper burner assembly 50, e.g., a broil burner assembly may be included in oven appliance 10. Upper burner assembly 50 may include a heating element 52 which is disposed within the cooking chamber 14, such as adjacent the top wall 30. In exemplary embodiments as illustrated, the upper burner assembly 50 is a gas burner assembly, and the heating element 52 is thus a gas burner tube. Alternatively, the upper burner assembly 50 may be an electric burner assembly and thus include an electric heating element, or may be any other suitable burner assembly having any other suitable heating element.

The operation of oven appliance 10 including heating assemblies 40 and 50 may be controlled by a processing device such as a controller 60, which may include a microprocessor or other device that is in communication with such components. Such controller 60 may, for example, also be in communication with a temperature sensor (not shown) that is used to measure temperature inside cooking chamber 14 and provide such measurements to the controller 60.

Oven appliance 10 may further include a user interface 62, which may as shown be located within convenient reach of a user of the oven appliance 10. User interface 62 is generally a component that allows a user to interact with the oven appliance 10 to, for example, turn various heating elements on and off, adjust the temperature of the heating elements, set built-in timers, etc. A user interface 62 may include a touchscreen 64 and a graphical display 66, which may be separate from or a part of the touchscreen 64. Touchscreen 64 and/or graphical display 66 may include one or more panel assemblies 68. A surface of an outer panel assembly 68 may, for example, serve as the point-of-contact for a user touching the touchscreen. The touchscreen 64 may be utilized by a user to interact with the oven appliance 10 by touching the touchscreen 64 directly with, for example, a finger. Various commands for a user to select through such touching may be displayed by touchscreen 64, and detection of the user selecting a specific command by touching a distinct location on the touchscreen 64 may be detected by the controller 60, which is in communication with the touchscreen 54, based on electrical signals from the touchscreen 64. Graphical display 66 may generally deliver certain information to the user, which may be based on user selections and interaction with the touchscreen 64, such as whether a particular heating element is activated and/or the level at which the heating element is set.

Notably, controller 60 may be in communication with the touchscreen 64, graphical display 66, and one or more heating elements. Accordingly, input signals received from the touchscreen 64 may be provided to and interpreted by the controller 60, and the controller 60 may output corresponding control signals to the heating elements to operate the heating elements as desired.

Controller 60 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 60 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. User interface 62 and other components of oven appliance 10 may be in communication with controller 60 via one or more signal lines or shared communication busses.

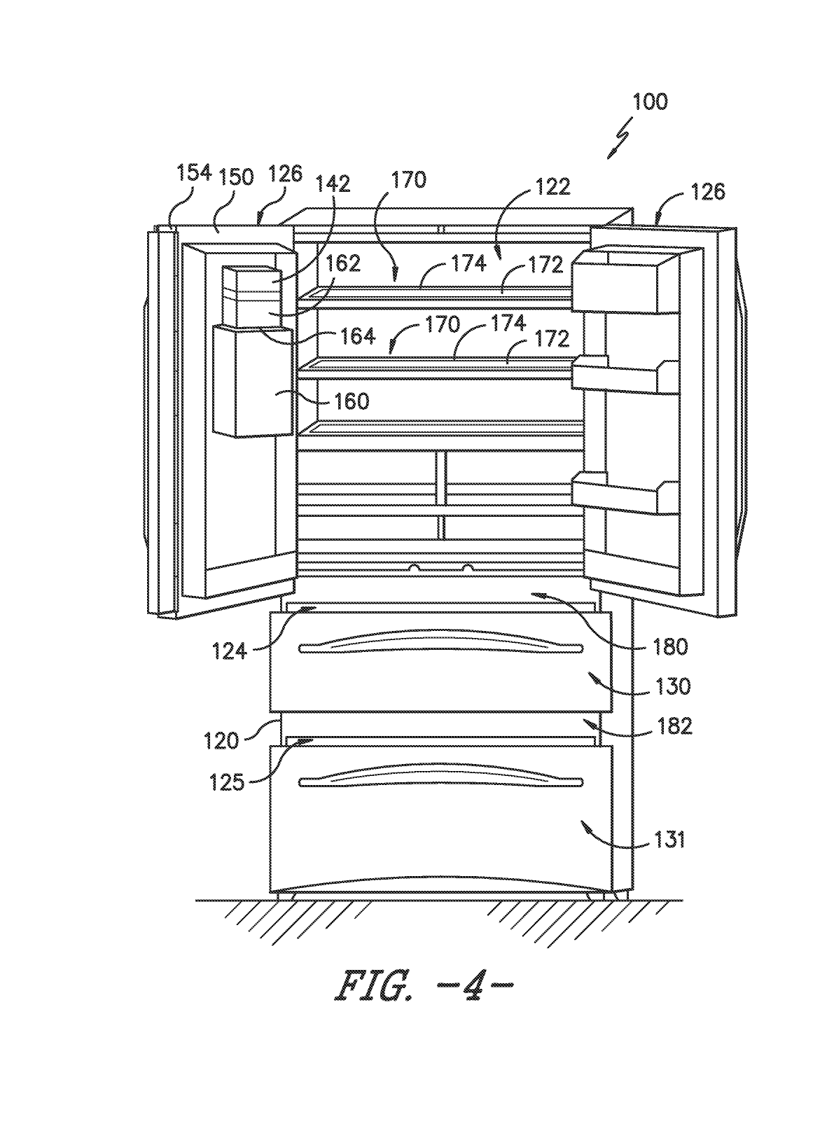

FIG. 3 is a front view of an exemplary embodiment of a refrigerator appliance 100. Refrigerator appliance 100 extends between a top 101 and a bottom 102 along a vertical direction V. Refrigerator appliance 100 also extends between a first side 105 and a second side 106 along a horizontal direction H. Further, refrigerator appliance 100 extends between a front 108 and a back 109 along a transverse direction T, which may be defined perpendicular to the vertical and horizontal directions V, H.

Refrigerator appliance 100 includes a cabinet or housing 120 defining a fresh food chamber 122 and one or more freezer chambers, such as first freezer chamber 124 and second freezer chamber 125, which may be arranged below the fresh food chamber 122 on the vertical direction V. As such, refrigerator appliance 100 may generally be referred to as a bottom mount refrigerator. In the exemplary embodiment, housing 120 also defines a mechanical compartment (not shown) for receipt of a sealed cooling system (not shown). Using the teachings disclosed herein, one of skill in the art will understand that the present invention can be used with other types of refrigerators (e.g., side-by-sides) or a top freezer appliance as well. Consequently, the description set forth herein is for illustrative purposes only and is not intended to limit the invention in any aspect.

Refrigerator doors 126 are rotatably hinged to an edge of housing 120 for accessing fresh food chamber 122. For example, upper and lower hinges may couple each door 126 to the housing 120. It should be noted that while two doors 126 in a “french door” configuration are illustrated, any suitable arrangement of doors utilizing one, two or more doors is within the scope and spirit of the present disclosure. Freezer doors, such as first freezer door 130 and second freezer door 131, are arranged below refrigerator doors 126 for accessing freezer chamber, such as first and second freezer chambers 124, 125, respectively. In the exemplary embodiment, freezer doors 130, 131 are coupled to freezer drawers (not shown) slidably coupled within freezer chambers 124, 125. Such drawers are thus generally “pull-out” drawers in that they can be manually moved into and out of the freezer chambers 124, 125 on suitable slide mechanisms.

FIG. 4 is a perspective view of refrigerator appliance 100 having refrigerator doors 126 in an open position to reveal the interior of the fresh food chamber 122. Additionally, freezer doors 130, 131 are shown in open positions to reveal the interior of the freezer chambers 124, 125.

A door 126 of the refrigerator appliance 100 may include an inner surface 150 and an outer surface 152. The inner surface 150 generally defines the interior of the fresh food chamber 122 when the door 126 is in a closed position as shown in FIG. 1, while the outer surface 152 is generally opposite the inner surface 150 and defines the exterior of the refrigerator appliance. Side surfaces 154 may extend between and connect the inner surface 150 and outer surface 152.

One or more shelves 170 may be disposed within the fresh food chamber 122 and/or a freezer chamber 124, 125 for placing articles thereon in the chamber(s). Each shelf may include a panel assembly 172, and may further include a frame at least partially surrounding the panel assembly 174.

Refrigerator appliance 100 may further include a dispensing assembly 110 for dispensing water and/or ice. Dispensing assembly 110 includes a dispenser 114 positioned on an exterior portion of refrigerator appliance 100. Dispenser 114 includes a discharging outlet 134 for accessing ice and water. A single paddle 132 is mounted below discharging outlet 134 for operating dispenser 114. A user interface 136 is provided for controlling the mode of operation. For example, user interface 136 may include a water dispensing button (not labeled) and an ice-dispensing button (not labeled) for selecting a desired mode of operation such as crushed or non-crushed ice.

Discharging outlet 134 and paddle 132 as shown are an external part of dispenser 114, and are mounted in a recessed portion 138 defined in an outside surface of refrigerator door 126. Recessed portion 138 is positioned at a predetermined elevation convenient for a user to access ice or water enabling the user to access ice without the need to bend-over and without the need to access freezer chamber 124. In the exemplary embodiment, recessed portion 138 is positioned at a level that approximates the chest level of a user.

Further components of dispensing assembly 110 are illustrated in FIG. 4. Dispensing assembly 110 includes an insulated housing 142 mounted to door 126. Due to the insulation which encloses insulated housing 142, the temperature within insulated housing 142 can be maintained at levels different from the ambient temperature in the surrounding fresh food chamber 122.

The insulated housing 142 is constructed and arranged to operate at a temperature that facilitates producing and storing ice. More particularly, the insulated housing 142 contains an ice maker for creating ice and feeding the same to an ice container 160, both of which may be mounted on refrigerator door 126. As illustrated in FIG. 4, container 160 is placed at a vertical position on refrigerator door 126 that will allow for the receipt of ice from a discharge opening 162 located along a bottom edge 164 of insulated housing 142.

The operation of refrigerator appliance 100 may be controlled by a processing device such as a controller 180, which may include a microprocessor or other device that is in communication with such components. Refrigerator appliance 100 may further include user interface 136, as mentioned. User interface 136 is generally a component that allows a user to interact with the refrigerator appliance 100 to, for example, adjust the temperature of various cooling assemblies, dispense ice and/or water, set built-in timers, etc. A user interface 136 may include a touchscreen 184 and a graphical display which may be separate from or a part of (as shown) the touchscreen 64. Touchscreen 184 and/or graphical display may include one or more panel assemblies 188. A surface of an outer panel assembly 188 may, for example, serve as the point-of-contact for a user touching the touchscreen. The touchscreen 184 may be utilized by a user to interact with the refrigerator appliance 100 by touching the touchscreen 184 directly with, for example, a finger. Various commands for a user to select through such touching may be displayed by touchscreen 184, and detection of the user selecting a specific command by touching a distinct location on the touchscreen 184 may be detected by the controller 180, which is in communication with the touchscreen 184, based on electrical signals from the touchscreen 184. The graphical display may generally deliver certain information to the user, which may be based on user selections and interaction with the touchscreen 184, such as temperatures maintained within the various chambers, etc.

Notably, controller 180 may be in communication with the touchscreen 184, graphical display, and one or more cooling assemblies (which may operate in refrigeration cycles, as is generally understood) and/or other components of the refrigerator appliance 100. Accordingly, input signals received from the touchscreen 184 may be provided to and interpreted by the controller 180, and the controller 180 may output corresponding control signals to the cooling assemblies, etc. to operate the cooling assemblies, etc. as desired.

Controller 180 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 180 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. User interface 136 and other components of refrigerator appliance 100 may be in communication with controller 180 via one or more signal lines or shared communication busses.

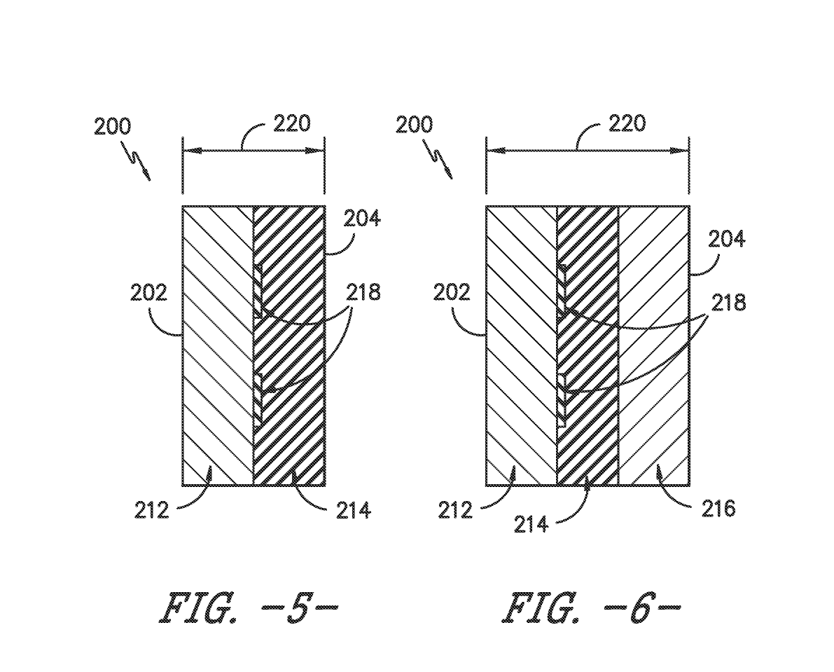

Referring now to FIGS. 5 through 7, embodiments of a panel assembly 200 for use with an appliance are provided. The appliance may be for example, an oven appliance 10 or refrigerator appliance 100, or alternatively, may be another suitable appliance such as a dishwasher appliance, microwave appliance, washer appliance, dryer appliance, etc. Panel assembly 200 may be disposed on or within a body of the appliance. For example, in some embodiments, panel assembly 200 may be a panel assembly 22 and the body may be door 16. Alternatively, panel assembly 200 may be a panel assembly 68, and the body may be cabinet 12, a door 16, or another suitable component of oven appliance 10 on which user interface 62 is provided. Alternatively, panel assembly 200 may be panel assembly 172, and the body may be a chamber 122, 124, 125 of refrigerator appliance 100. Alternatively, panel assembly 200 may be a panel assembly 188, and the body may be door 126, another suitable door, housing 120, or another suitable component of oven appliance 10 on which user interface 136 is provided. It should be understood, however, that the present disclosure is not limited to the above-described embodiments, and rather that any suitable panel assemblies on or within any suitable bodies of any suitable appliances are within the scope and spirit of the present disclosure.

As illustrated, a panel assembly 200 may include an outer surface 202 and an inner surface 204. The outer surface 202 may, for example, be the exterior facing surface or vertically upward facing surface of a panel assembly 200 when installed in an appliance. The inner surface 204 opposes the outer surface 202.

Panel assembly 200 may further include a first layer 212 and a second layer 214. The first layer 212 includes the outer surface, and is a glass. In exemplary embodiments, the glass is tempered glass. As is generally understood, tempered glass is formed from annealed glass via, for example, a thermal tempering process or chemical toughening process. For example, annealed glass may be heated in a furnace to above its transition temperature and then rapidly cooled with forced air drafts. Tempering generally places the outer surfaces of the glass into compression and the inner surfaces of the glass into tension. The resulting tempered glass has increased strength relative to regular, non-tempered glass.

The second layer 214, such as a facing surface thereof, is partially or fully in contact with and bonded to the first layer 212, such as with a facing surface thereof. In general, any suitable bonding process, including lamination using heat and/or pressure or curing may be utilized to bond the second layer 214 to the first layer 212. The second layer is formed from a polymer, such as from a thermoplastic or thermoset polymer. For example, in some embodiments, the second layer 214 may include polyvinyl butyral, ethylene-vinyl acetate and/or polyurethane.

Use of a polymer second layer 214 bonded to the first layer 212 may advantageously increase the safety of the panel assembly 200 if and when the panel assembly 200 is broken. For example, the second layer 214 may hold broken chunks of the first layer 212 together upon breaking, thus reducing the amount of clean-up required, reducing the risk of missing chunks when cleaning up the broken panel assembly 200, and reducing the risk of being injured by chunks of the first layer 212.

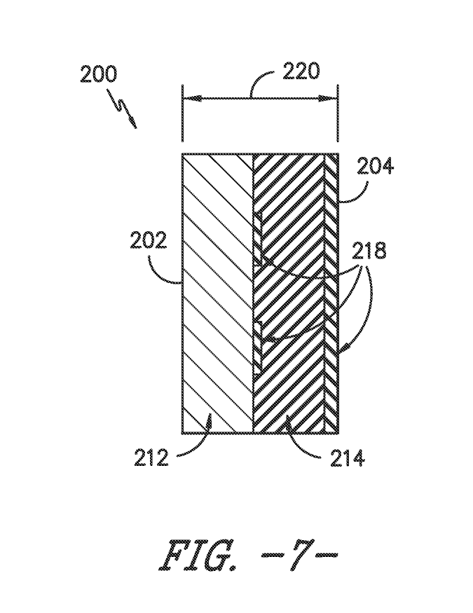

In some embodiments, as illustrated in FIG. 5, the second layer 214 may include the inner surface 204. In other embodiments, as illustrated in FIG. 6, a third layer 216 may be included in the panel assembly 200. The second layer 214 may be disposed between the first and third layers 212, 216, and the third layer 216 may include the inner surface 204. In exemplary embodiments, the third layer 216 is a glass, such as a tempered glass. Similar to with the first layer 212, the second layer 214, such as a facing surface thereof, may be partially or fully in contact with and bonded to the third layer 216, such as with a facing surface thereof.

Referring to FIGS. 5 through 7, in some embodiments a decorative layer 218 may be disposed between the first layer 212 and the second layer 214 (and/or between the second layer 214 and third layer 216). Decorative layer 218 generally includes an ink 218. In some embodiments, the decorative layer 218 may include a ceramic-based ink. A ceramic ink typically includes ceramic frit and inorganic pigments and other elements. In other embodiments, the decorative layer 218 may include a polymer-based ink. For example, in some exemplary embodiments, the polymer-based ink includes a thermoset, and can be applied as a liquid and cured onto and/or between one or both of the surrounding layers 212, 214, 216. A variety of colors can be utilized for the decorative layer 218, which may generally be utilized to provide designs on the panel assembly 200 as desired or required.

In some embodiments, as illustrated in FIG. 7, a decorative layer 218 may be positioned to additionally or alternatively include the inner surface 204, and thus may be coated on an inner surface of the second layer 214, as shown, or third layer 216. The second layer 214 (and optionally the third layer 216) may be disposed between the first and decorative layers 212, 218.

Panel assemblies 200 in accordance with the present disclosure may be relatively thin. For example, in exemplary embodiments, a thickness 220 of a panel assembly 200 between outer surface 202 and inner surface 204 may be less than or equal to approximately 4 millimeters.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance, the appliance comprising:
an appliance body; and
a panel assembly disposed on or within the appliance body, the panel assembly comprising:
an outer surface;
an inner surface;
a first layer comprising the outer surface, wherein the first layer is a glass; and
a second layer at least partially in contact with and bonded to the first layer, wherein the second layer is a polymer.

2. The appliance of claim 1, wherein the first layer is a tempered glass.

3. The appliance of claim 1, wherein the second layer is a thermoplastic.

4. The appliance of claim 1, wherein the second layer is a thermoset.

5. The appliance of claim 1, wherein the second layer comprises polyvinyl butyral.

6. The appliance of claim 1, wherein the second layer comprises ethylene-vinyl acetate.

7. The appliance of claim 1, wherein the second layer comprises polyurethane.

8. The appliance of claim 1, wherein the second layer comprises the inner surface.

9. The appliance of claim 1, further comprising a third layer comprising the inner surface, wherein the third layer is a glass, and wherein the second layer is at least partially in contact with and bonded to the third layer.

10. The appliance of claim 1, further comprising a decorative layer disposed between the first layer and the second layer, the decorative layer comprising an ink.

11. The appliance of claim 1, further comprising a decorative layer comprising the inner surface, the decorative layer comprising an ink.

12. The appliance of claim 1, wherein the appliance body is a refrigerator body and the panel assembly is a shelf panel assembly.

13. The appliance of claim 1, wherein the appliance body is an oven body and the panel assembly is a door panel assembly.

14. The appliance of claim 1, wherein the panel assembly is a touchscreen for a user interface.

15. The appliance of claim 1, wherein a thickness of the panel assembly between the outer surface and the inner surface is less than or equal to approximately 4 millimeters.

16. An oven appliance, comprising:
a cabinet defining a cooking chamber, the cooking chamber configured for receipt of items to be cooked;
a door rotatably mounted to the cabinet, the door comprising a panel assembly;
a controller; and
a user interface in communication with the controller, the user interface comprising a panel assembly,
wherein at least one of the panel assembly of the door or the panel assembly of the user interface comprises:
an outer surface;
an inner surface;
a first layer comprising the outer surface, wherein the first layer is a glass; and
a second layer at least partially in contact with and bonded to the first layer, wherein the second layer is a polymer.

17. The oven appliance of claim 16, further comprising a decorative layer disposed between the first layer and the second layer, the decorative layer comprising a polymer ink.

18. A refrigerator appliance, comprising:
a cabinet defining a fresh food chamber;
a fresh food door rotatably hinged to the cabinet for accessing the fresh food chamber;
a shelf disposed within the fresh food chamber, the shelf comprising a panel assembly;
a controller; and
a user interface in communication with the controller, the user interface comprising a panel assembly,
wherein at least one of the panel assembly of the shelf or the panel assembly of the user interface comprises:
an outer surface;
an inner surface;
a first layer comprising the outer surface, wherein the first layer is a glass; and
a second layer at least partially in contact with and bonded to the first layer, wherein the second layer is a polymer.

19. The refrigerator appliance of claim 18, further comprising a third layer comprising the outer surface, wherein the third layer is a glass, and wherein the second layer is at least partially in contact with and bonded to the third layer.

20. The refrigerator appliance of claim 18, further comprising a decorative layer disposed between the first layer and the second layer, the decorative layer comprising a polymer ink.
